(19) United States
(12) Patent Application Publication
(10) Pub. No.: US 2025/0238300 A1
(43) Pub. Date: Jul. 24, 2025

(54) LARGE LANGUAGE MODELS FOR EFFICIENT ANOMALY DETECTION IN LOG FILES OF INDUSTRIAL MACHINES

(71) Applicant: NANO DIMENSION TECHNOLOGIES LTD, Ness Ziona (IL)

(72) Inventors: Ben LEVY, Ramat Gan (IL); Marina IZMAILOV, Rehovot (IL); Katia HURI, Givatayim (IL); Eri RUBIN, Ma'ale Ha'hamisha (IL); Eli DAVID, Tel Aviv (IL)

(73) Assignee: NANO DIMENSION TECHNOLOGIES LTD, Ness Ziona (IL)

(21) Appl. No.: 18/416,704

(22) Filed: Jan. 18, 2024

(51) Int. Cl. G06F 11/07; G06F 40/40

(52) U.S. Cl. CPC G06F 11/0781; G06F 40/40

(57) ABSTRACT

Abnormal behavior detection for industrial machines component(s) using large language models based on sequence(s) of log file messages recorded by logger(s) at initial time(s). The log file message sequence may be transformed into an anomaly severity sequence comprising log tokens encoding, times, and/or associated anomaly severity levels. The anomaly severity sequence may be input into the large language model. The large language model may output an anomaly severity histogram predicting M probabilities that the logger(s) will record log file messages encoded by log keys associated with M respective anomaly severity levels at the subsequent time(s). Abnormal behavior may be predicted based on the M probability patterns of the anomaly severity histogram. in the one or more components of the industrial machine logged by the one or more loggers at the one or more subsequent times. A control command may trigger automatically altering the component(s) operation to prevent the abnormal behavior.

### FIELD OF THE INVENTION

Embodiments of the invention are related to the field of detecting anomalous behavior of industrial machines by analyzing their log files. In particular, embodiments of the invention are related to using machine learning to automate log file analysis of industrial machines.

### BACKGROUND OF THE INVENTION

Industrial machines produce log files, for example, timestamped data records or “tokens” of various states of their various components. Each token may detail information, such as, errors, temperature changes, pressure changes, processor functions, etc. For example, a three-dimensional (3D) printer may have log files indicating color(s) extracted from an ink cartridge, viscosity, temperature and humidity of the ink, electric or dielectric pixel patterns for printing, a signal when printing is performed, etc.

Log files are used to troubleshoot a problem when the industrial machine has an error, malfunctions, underperforms or fails. Since log files are often the only resource to recover and troubleshoot errors after a failure, log files are generally designed to be over inclusive and highly specific to anticipate and record all states of all components of industrial machines. As such, industrial machines tend to generate log files having massive data sizes (e.g., terabytes of data) and token types (e.g., thousands of different tokens). These log files are often unordered, unlabeled, and unstructured. In some cases, log files are not timestamped. Further, the mapping between components and log files may be one-to-one, one-to-many, many-to-one or many-to-many, complicating the interrelationship between components and log file tokens. The result are log files of massive size of mostly irrelevant data that can take human operators days of analysis to sort through to determine the cause of a machine error.

To solve this problem, machine learning solutions were developed to automatically analyze log files for root causes of industrial machine errors. Training these machine learning models, however, uses supervised learning that requires log file tokens to be labeled as associated with normal or abnormal functioning components or machines. Most log files, however, are unlabeled and it is cumbersome, if not impossible, to label these massive data sources for supervised training. Accordingly, training relies on the scarce resource of labeled log files which limits training accuracy. Further, the cause of machine errors are often unknown, or emerge from unknown combinations of multi-component states, and so, cannot be labeled.

Additionally, high token variety and specificity (e.g., hundreds or thousands of different types of tokens) makes it difficult to predict the next log token at a future time with sufficient and stable accuracy. High token variety also causes the large language model to explode in size, for example, growing by a power of the number of different possible tokens, thereby consuming massive memory and processor resources for the model's training and prediction. High token variety also limits the future prediction time because with such specificity the accuracy of the model's prediction quickly degrades as time increases. For example, accurate predictions (e.g., with at least 70% threshold accuracy) may only be reliably achieved in small timescales (e.g., within 1-2 seconds in the future). Such myopic prediction often make it impractical or impossible to act or respond to take corrective or preventative action in time to prevent predicted anomalies before they occur (e.g., after turning up a device's temperature, it may take more time for a printing substrate to heat than is needed to avoid printer error or failure).

Accordingly, there is a need in the art for efficient and accurate machine learning models for analyzing unstructured log files to predict root causes of industrial machine errors, e.g., on larger timescales, without human intervention.

### SUMMARY OF THE INVENTION

Embodiments of the invention may transform industrial machine log file messages indicating specific logged device behavior at a current time ti to predict a severity histogram that estimates multiple probabilities of anomalies of multiple respective severity levels occurring at a future time tj. Log file tokens are typically relatively highly specific (e.g., N=thousands of different log tokens) represented in a relatively high N-dimensional vector space compared to a severity histogram that characterizes relatively general anomaly severity levels (e.g., M=5-10) represented in a relatively small M-dimensional vector space (e.g., M<<N). Reducing the dimension of the output space from N to M, reduces the dimensions of internal LLM data structures (e.g., by tens or thousands as discussed in reference to the transformer(s) of FIGS. 2, 3A-3B).

Compared to next token prediction that model an N-dimensional vector space to predict probabilities for all N possible next log tokens, large language models according to embodiments of the invention provide a significantly reduced M-dimensional vector space to predict an M-dimensional anomaly severity histogram of M possible log severity levels. Modeling the M-dimensional anomaly severity histogram alters the structure of the large language model to a more compact and efficient machine learning engine that uses reduced size data structures, reduced memory, reduced computations, and faster processing speeds, compared to next token prediction (see e.g., the compact transformer(s) of FIGS. 2, 3A-3B).

Reducing the dimension of the modeled vector space further improves prediction accuracy and stability at larger timescales into the future. Extending the predictive timescale of anomaly detection allows more time to prevent or correct errors before they occur, thus benefitting the operation of the industrial machines.

According to some embodiments of the invention, there is provided a device, system and method for detecting abnormal behavior in industrial machines. A sequence of log file messages may be received, recorded at one or more initial times by one or more loggers, of operations of one or more components in an industrial machine. The sequence of log file messages may be transformed into an anomaly severity sequence comprising a sequence of log tokens encoding the log file messages, time between log file token pairs, and/or a sequence of anomaly severity levels each associated with one or more of the log tokens. The anomaly severity sequence at the one or more initial times may be input into the large language model trained to predict anomaly severity histograms at one or more subsequent times. An anomaly severity histogram may be output predicting a plurality of M distinct probabilities that the one or more loggers will record log file messages encoded by one or more log keys associated with M respective distinct anomaly severity levels at the one or more subsequent times. Abnormal behavior may be predicted in the one or more components of the industrial machine logged by the one or more loggers at the one or more subsequent times when the anomaly severity histogram indicates a pattern of the M probabilities associated with the abnormal behavior. Upon predicting the abnormal behavior, a control command may be sent to the industrial machine to trigger automatically executing an action, for example, to alter the operation of the one or more components, to prevent the abnormal behavior from occurring before the one or more subsequent times.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an industrial machine comprising a logger generating log files analyzed by a machine learning engine to predict future anomaly severity histograms to detect log file anomalies, in accordance with some embodiments of the invention;

FIG. 2 is a schematic illustration of a single-sequence transformer to predict future anomaly severity histograms for log files, in accordance with some embodiments of the invention;

FIGS. 3A-3B are schematic illustrations of a multi-sequence transformer to predict future anomaly severity histograms for log files, in accordance with some embodiments of the invention;

FIG. 4 is a schematic illustration of a system for detecting abnormal behavior in industrial machines by predicting future anomaly severity histograms for log files, in accordance with some embodiments of the invention; and

FIG. 5 is a flowchart of a method for detecting abnormal behavior in industrial machines by predicting future anomaly severity histograms for log files, in accordance with some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Embodiments of the invention provide a large language model, such as a transformer, that inputs a sequence of log tokens representing log file messages recorded by one or more logger(s) measuring operations at one or more component(s) in one or more industrial machine(s) at an initial (current) time ti, and outputs a predicted anomaly severity histogram at a subsequent (future) time tj. An anomaly severity histogram estimates multiple M probabilities that the loggers will record anomalous log file messages associated with multiple M different respective severity levels of abnormal behavior at the industrial machine components.

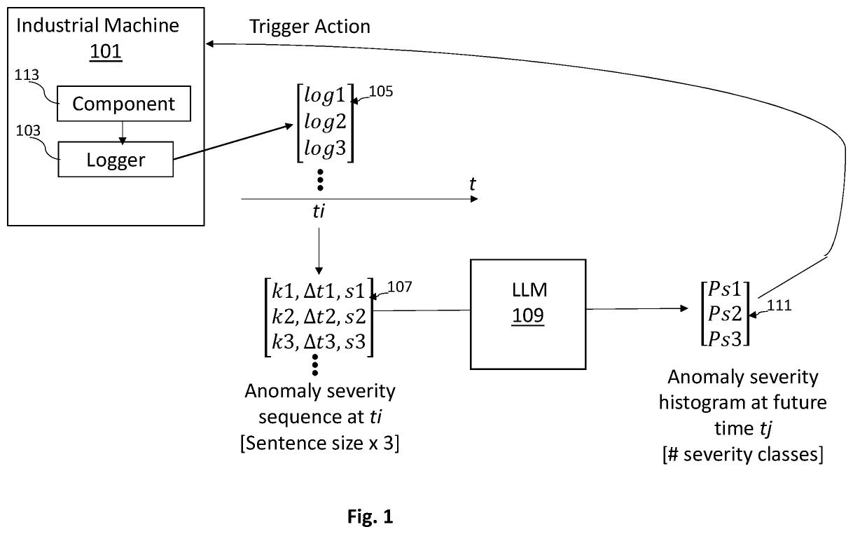

Reference is made to FIG. 1, which is a schematic illustration of an industrial machine 101 comprising one or more logger(s) 103 generating log files analyzed by a large language model 109 to predict future anomaly severity histograms to detect log file anomalies, in accordance with some embodiments of the invention.

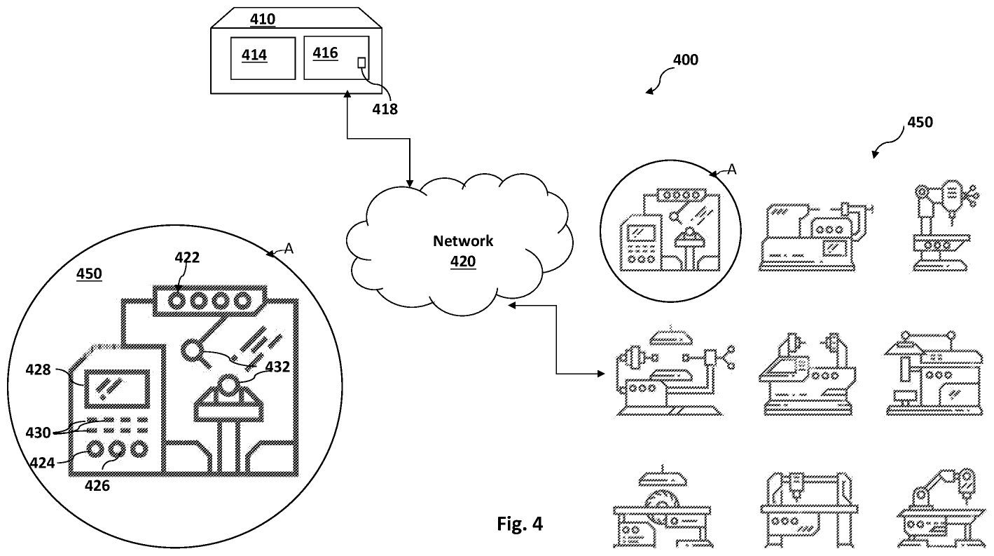

Logger(s) 103 (e.g., logger(s) 430 of FIG. 4) may record operation, status and/or function of one or more components 113 (e.g., component(s) 432 of FIG. 4) in industrial machine 101 (e.g., industrial machine(s) 450 of FIG. 4) to generate one or more log file(s) comprising a sequence of log messages {log 1, log 2, . . . , logq}105 recorded by logger(s) 103 at an initial (e.g., current) time ti (e.g., at a single time ti or over a duration up to the time t0, . . . , ti). The sequence of log messages 105 may be transformed to an anomaly severity sequence {k1,Δt1,s1; k2,Δt2,s2; . . . ; kp,Δtp,sp} 107 comprising uniform syntax of log tokens (ki) encoding the log file messages, time between log file token pairs (Δti), and a sequence of anomaly severity levels (si) each associated with one or more of the log tokens, at the initial time ti. Anomaly severity sequence 107 may have dimension equal to the sequence 107 length, its duration, or number of tokens therein p×3. Other syntax and dimensions may be used. For example, sequence 107 format and/or data may be reordered, interchanged, replaced with equivalent or derivable data. In one example, time between log file token pairs (Δti) may be omitted when a standard or known time duration is used, or may be replaced with a start or end time associated with token (ki).

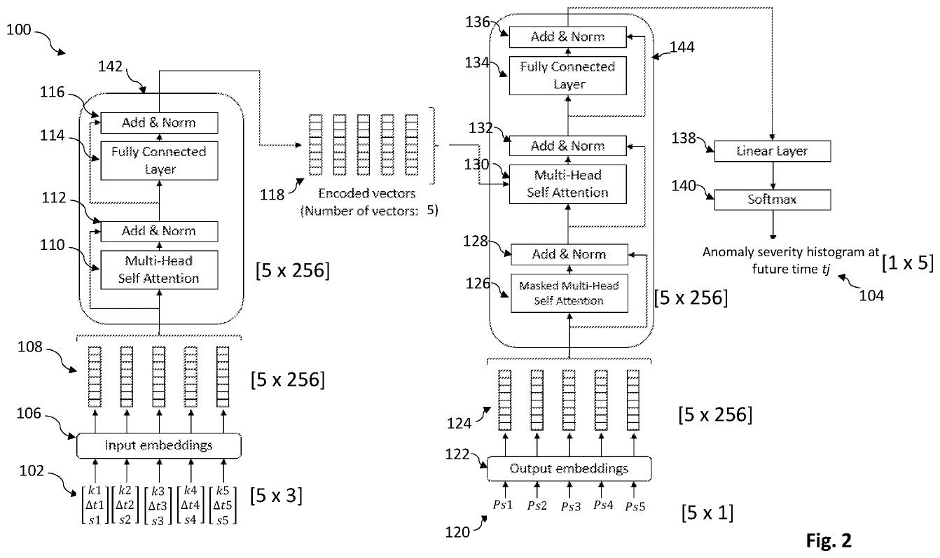

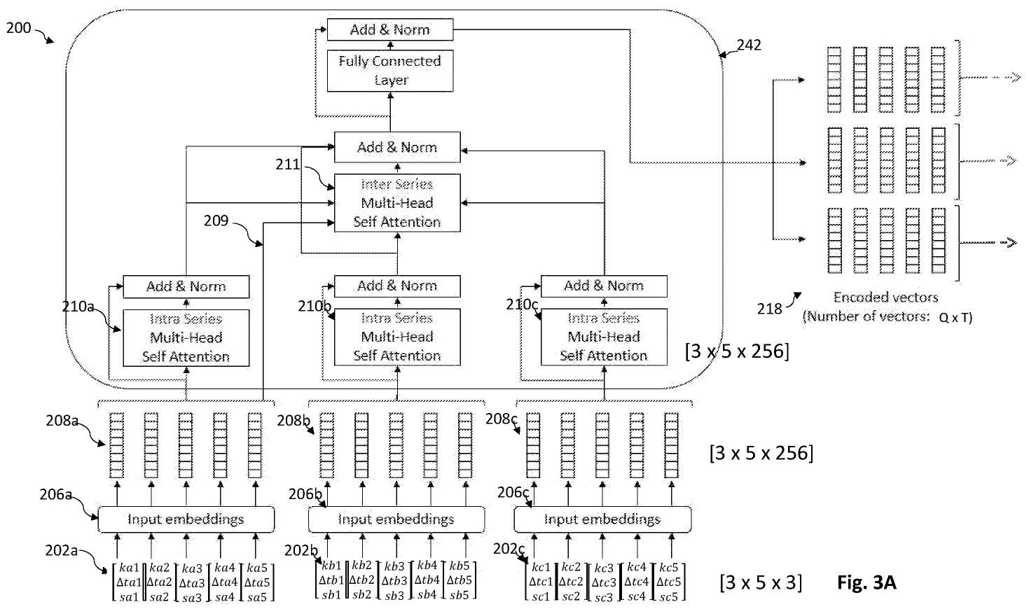

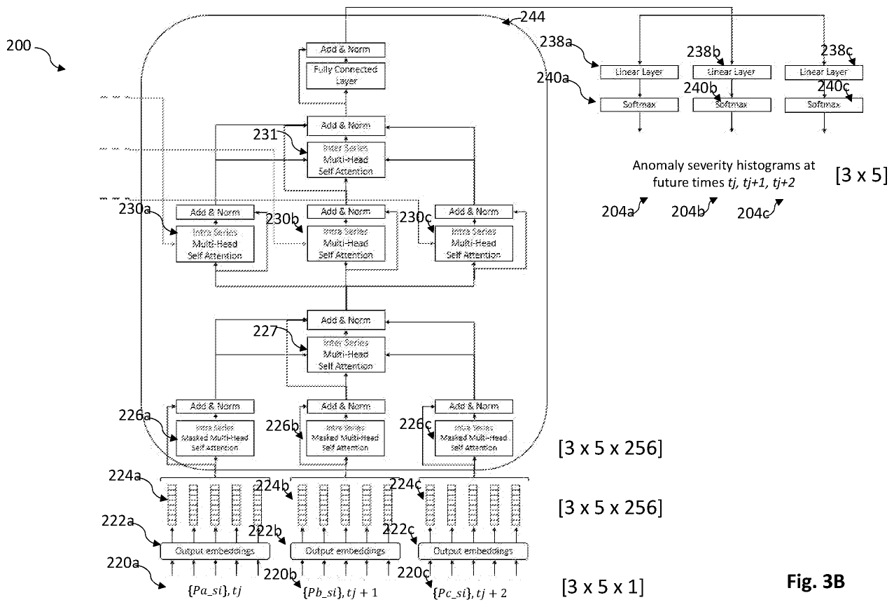

A large language model 109, such as the transformers shown in FIGS. 2-3B, may be trained to input anomaly severity sequences at initial times ti and output anomaly severity histograms at subsequent times tj. Upon inputting anomaly severity sequence 107 at the initial time ti, the large language model 109 may compute and output anomaly severity histogram 111 predicting a plurality of M distinct probabilities {Ps1, Ps2, . . . , PsM} that the one or more loggers will record log file messages encoded by one or more log keys associated with M respective distinct anomaly severity levels {s1, s2, . . . , sM} at the subsequent time tj (e.g., M=5-10).

An anomaly detection device may analyze anomaly severity histogram 111 to predict abnormal behavior in the component(s) 113 of industrial machine 101 logged by logger(s) 103 at subsequent time tj when the received anomaly severity histogram 111 indicates a probability pattern trained to be associated with the abnormal behavior. The analysis may be performed, e.g., using rules-based or machine learning models.

In response to predicting the abnormal behavior, the anomaly detection device may send industrial machine 101 a control command to trigger industrial machine 101 to automatically execute an action (e.g., automatically alter component(s) 113 operation) to prevent the abnormal behavior from occurring before the subsequent time tj. Large language model 109 may thus be used to predict failures before they occur, are logged and/or are detected in a machine, enabling predictive maintenance to preemptively prevent a failure. In some embodiments, large language model 109 may be coupled, or operably connected, to industrial machine 101 controls to automatically adjust, start or stop component(s) 113 if future failure or error is predicted. In one example, when large language model 109 detects overheating, a signal may be automatically sent to a printing head component to reduce heat, stop printing and/or restart printing when the transformer detects or predicts the temperature has normalized.

LLM 109 predicting an anomaly severity histogram according to embodiments of the invention accelerates anomaly detection compared to predicting a next log sequence token. A next token prediction LLM models an N-dimensional search space to predict N probabilities that a next token following an input token sequence is any of N respective possible values (e.g., N is the logger vocabulary size or the number of distinct possible log tokens, such as, approximately 50,000 for the English language). In contrast, the large language model according to embodiments of the invention only models an M-dimensional search space to predict an anomaly severity histogram with M probabilities {Ps1, Ps2, . . . , PsM} of logging a next token with M respective severity levels {s1, s2, . . . , sM}(e.g., M is the number of distinct anomaly severity levels si, such as, 5-10). In practice, loggers encode vast numbers N of highly-specific log tokens to accurately record and diagnose machine behavior, whereas only relatively few M general anomaly severity levels may be used to identify the severity of that behavior, such that M is significantly less than N (e.g., M=5<<N=50,000).

Reducing the LLM search space from N-dimensions (for next token prediction) to a significantly smaller M-dimensions (for anomaly severity histogram prediction) alters the LLM data structures to create a significantly more compact large language model 109. For example, as described in reference to the transformer of FIG. 2 below, some layers of next token LLM have dimensions p×N (e.g., 5×50,000) that are larger than dimensions of comparable layers in LLM 109 by a factor of at least ten(s) and up to hundred(s) of times. Because it is drastically more compact, M-dimension LLM 109 operates at significantly faster prediction and training speeds (e.g., at processor 414 and 424 of FIG. 4), reduces memory usage (e.g., in memory units 416 and 426 of FIG. 4), and reduces computations (e.g., executed by processor 414 and 424 of FIG. 4) compared to N-dimension LLMs. For example, the compact transformer of FIG. 2 reduces the dimensions of embedding input and output vectors from [5×50,000] in N-dimension LLMs to [5×256] yielding approximately a 200× reduction in storage usage and a 200× speedup in processing time for these vectors and their input layers, and further reductions in subsequent layers (e.g., depending on the number and size of the hidden layers).

Additionally, the next token LLM predicts one logkey at a time to forecast only one time step into the future (e.g., typically 1 millisecond). In contrast, due to its compactness and relatively small M-dimensional output space, LLM 109 may predict an anomaly severity histogram 111 for a significant time interval (e.g., 10 minutes of time into the future that may contain 600,000 time steps). Compared to the next token LLM, LLM 109 may increase the prediction timescale by factor of 600,000 in this example (e.g., executed at processor 414 and 424 of FIG. 4). Because prediction of one time-step at a time consumes impractical computational and memory resources, next token LLMs may try to increase the output size to be greater than 1, but this explodes output sizes by a factor of the timestep, which GPU hardware cannot practically manage for significant timescales (e.g., greater than 10 or 100). Because the output dimension of LLM 109 is based on the number of severity levels M, not on the future prediction timescale (also referred to as the “horizon size”), LLM 109 operates with the same efficiency regardless of the size of the time-step it predicts into the future. Compared to the next token LLM, LLM 109 may predict severity levels for 10 minutes in seconds or minutes instead of hours or days for 600,000 one-logkey-at-a-time or thousands of small scale (10-100 next token) iterations.

Reference is made to FIG. 2, which is a schematic illustration of a single-sequence transformer 100 to predict future anomaly severity histograms 104, in accordance with some embodiments of the invention. Transformer 100 may be a (e.g., fully-connected) deep learning neural network. The left-side of FIG. 2 depicts the transformer's encoder 142 and the right-side of FIG. 2 depicts the transformer's decoder 144. Dimensions of data structures are indicated in hard brackets to the right of the associated data structure and are provided as non-limiting examples.

Single-sequence transformer 100 may input an anomaly severity sequence 102, e.g., {k1, Δt1, s1; k2,Δt2,s2; . . . ; kp, Δtp,sp} of length p (e.g., 5, recorded over 5 initial times or intervals, up to a time ti). Anomaly severity sequence 102 may include a sequence of log tokens (ki) encoding log file messages, such as, words, subwords, or characters, from a vocabulary of N (e.g., 50,000) possible log tokens, times between log file token pairs (Δti), and a sequence of anomaly severity levels (si) from M (e.g., 5) possible log severity levels each associated with one or more of the log tokens.

Single-sequence transformer 100 may output an anomaly severity histogram 104 predicting a plurality of M distinct probabilities {Ps1, Ps2, . . . , Ps5} that a future log key at a subsequent time will be associated with M respective distinct anomaly severity levels {s1,s2, . . . , s5}. For example, a log token sequence encoding log messages, such as, “user stopped,” “system stopped,” or “machine stopped unexpectedly” are predicted to have high probabilities of “WARNING,” “ERROR,” or “CRITICAL” severity levels.

Whereas an LLM predicts a next token with an N-dimensional probability distribution for N possible tokens, LLM 100 according to embodiments of the invention predicts anomaly severity histogram 104 with a significantly smaller M-dimensional probability distribution for M possible severity levels, where M<<N. This significantly reduces the size of the LLM's data structures to generate a relatively compact and efficient model. Input severity embeddings 106 may embed each entry of anomaly severity sequence 102 {ki,Δti,si} into an embedded input severity vector 108 Vi in a high-dimensional vector space. Embedded input severity vectors 108 Vi may represent the interrelationship, such as, the semantic meanings, between each entry of anomaly severity sequence 102 {ki, Δti, si} and the other entries in the sequence 102. Whereas an LLM predicting a next token generates embedded input token vectors of dimension [sentence length p×vocabulary size N](e.g., 5×50,000), the LLM according to embodiments of the invention generates embedded input severity vectors 108 of dimension [number of severity levels×number of severity embeddings](e.g., 5×256). An optimal number of severity embeddings for M=5-10 has been experimentally determined to be 128, 256 or 512 and is significantly less than vocabulary size N.

Embedded input severity vectors 108 may be input into a multi-head self-attention layer 110 of encoder 142. Layer 110 performs self-attention on vectors 108 by weighing the importance of different entries when making predictions for each entry of anomaly severity sequence 102 {ki,Δti,si}. Layer 110 performs multi-head self-attention by applying the self-attention mechanism multiple times, in parallel, to concurrently focus attention on (e.g., multiple or all) different entries of anomaly severity sequence 102. For each entry {ki, Δti, si}, multi-head self-attention layer 110 may compute a weighted sum of all other entries' embedded input severity vectors 108, with the weights determined by the other entries' relevance to the current entry {ki,Δti,si}. Compared to N-dimensional next token LLMs, the drastic reduction in dimensions of embedded input severity vectors 108 in transformer 100 cause multi-head self-attention layer 110 to operate thereon at significantly faster speeds (e.g., tens or hundreds times faster with tens or hundreds times fewer computations and memory resources). In this example, a reduction in the dimension of embedded input vectors from [5×50,000] in N-dimension LLMs to [5×256] in vectors 108 of LLM 100 yields approximately a 200× reduction in storage usage and a 200× speedup in processing time for this layer, and further reductions in subsequent hidden layers.

The output sequence of multi-head self-attention layer 110 may be input into fully connected layer 114. Fully connected layer 114 may comprise a set of fully connected layers independently applied to each position in the sequence.

Encoder 142 may encode the outputs of fully connected layer 114 (e.g., normalized at layer 116) into p encoded vectors 118 EV₁, EV₂, . . . EVp.

Normalization layer 112 and/or 116 may combine and normalize inputs and/or outputs before and/or after each sub-layer (e.g., 110 and/or 114) to stabilize and speed up training.

Because embedded input vectors 108 in severity LLM 100 is significantly more compact than in an LLM predicting a next token, for comparable accuracy therebetween multi-head self-attention layer 108, fully connected layer 114, and normalization layer 112 in LLM 100 all have a significantly smaller size (e.g., 5×128 or 256) than the size (e.g., 5×512) of those layers in the LLM predicting a next token.

When transformer 100 is iterated to predict anomaly severity histograms 104 at two or more future times or log messages, decoder 144 may input severity embeddings of the output anomaly severity histogram 120 from a previous iteration (e.g., {Ps1, Ps2, . . . , PsM}) to predict the next anomaly severity histogram 104 in the current iteration. Output anomaly severity histogram 120 may be embedded by output severity embeddings 122 that embed each output severity entry Psi into a high-dimensional vector space. Embedded output severity vectors 124 may represent the interrelationship, such as, the semantic meanings, between each severity level's output probability Psi and the output probabilities for the other M−1 severity level in the output anomaly severity histogram 120. Whereas a next token LLM generates embedded input token vector of dimension [timestep×vocabulary size N](e.g., timestep×50,000), the LLM according to embodiments of the invention generates embedded output severity vectors 124 of dimension [number of severity levels×number of severity embeddings](e.g., 5×256). An optimal number of severity embeddings for M=5-10 has been experimentally determined to be 128, 256 or 512 and is significantly less than vocabulary size N.

Transformer 100 may use a masked multi-head self-attention layer 126 to generate an output sequence weighing the importance of different probabilities in the anomaly severity histogram 120 for each severity level si. The mask may be used during training to obfuscate the known actual token (e.g., used for error correction) so the prediction of this token is not known until after its prediction is made. Compared to N-dimensional next token LLMs, the drastic reduction in dimensions of embedded input severity vectors 124 in transformer 100 cause multi-head self-attention layer 126 to operate thereon at significantly faster speeds (e.g., tens or hundreds times faster with tens or hundreds times fewer computations and memory resources). In this example, a reduction in the dimension of embedded output vectors from [1×50,000] in N-dimension LLMs to [5×256] in vectors 124 of LLM 100 yields approximately a 40× reduction in storage usage and a 40× speedup in processing time.

Decoder 144 may input p encoded vectors 118 EV₁, EV₂, . . . EVp, and for example when the current iteration's anomaly severity histogram is predicated on a previous iteration's next anomaly severity histogram, may also input masked multi-head self-attention layer 126 output sequence, into multi-head self-attention layer 130. The output of multi-head self-attention layer 130 may be input (e.g., normalized at layer(s) 128 and/or 132) into fully connected layer 134. Decoder 144 may output the results of fully connected layer 134 (e.g., normalized at layer 136) and modeled into an output by linear layer 138, which is then passed to a softmax layer 140. Softmax layer 140 may generate anomaly severity histogram 104 predicting a plurality of M distinct probabilities {Ps1, Ps2, . . . , PsM} that a future log key at a subsequent time will be associated with M respective distinct anomaly severity levels {s1, s2, . . . , sM}.

During training mode, transformer 100 may continuously (e.g., periodically) input the input sequence 102 until p entries are entered at one or more initial times. Transformer 100 may then predict anomaly severity histogram 104 at one or more subsequent times. The actual anomaly severity histogram may be generated from metadata of log files or measured component malfunctions (e.g., by self-supervised learning) and training errors may be calculated (e.g., as the difference between the predicted and actual anomaly severity histograms at the one or more subsequent times). Transformer 100 may update (e.g., all or a subset of) the weights of transformer 100, e.g., using backpropagation, evolutionary modeling, or other error correction mechanisms to minimize errors. These operations may be repeated until the predicted and actual anomaly severity histograms match with an above threshold accuracy (e.g., the error or difference between prediction and actual result is smaller than a predefined threshold) and/or the predictive confidence of the softmax layer 240 satisfies a training termination criterion (e.g., the probability distribution, mean, standard deviation, or maximum value reaches a threshold range and/or converges). At this point, transformer 100 is trained, and may be retrained e.g. periodically or each time new data becomes available.

The relatively compact dimensions of LLM 100 for predicting severity levels (e.g., tens or hundreds of times smaller compared to predicting next tokens) accelerates training and prediction times, reduces memory usage, reduces computations, and widens the future prediction horizon times for anomaly detection in industrial machines. Increasing future prediction horizon times may allow more time for component(s) 113 to take corrective action to prevent and pre-emptively fix predicted errors before they occur. Widening the prediction horizon times can thus improve performance and function of industrial machines 101. In some embodiments, because LLM 100 is relatively compact, larger strings of log token entries can be simultaneously input into sequences 102 to predict in larger batches of data. For example, reductions in embedded vector dimensions by a factor of tens or hundreds allows LLM 100 to process an increase in batch size of by that factor with comparable efficiency. Not only is it faster to predict for larger batches of data, but it is also more accurate because LLM 100 takes into account more interrelationships between tokens spanning larger time intervals to capture more log message patterns.

Industrial machines sometimes generate multiple log file tokens simultaneously or concurrently, e.g., for multiple concurrently operating components and/or multiple properties for a single component. For example, an industrial machine may have tens or hundreds of “logger” components or output ports that write to a log file periodically and/or triggered by an event. The single-sequence transformer 100 of FIG. 2, however, is adapted to input and output a single ordered anomaly severity sequence {k1,Δt1,s1; k2,Δt2,s2; . . . ; kp, Δtp,sp}. Taking a parallelized set of concurrently generated log file tokens and ordering them into a single sequence 102 may impose an artificial and inaccurate sequential relationship and/or timing between parallel generated tokens.

To solve this problem, embodiments of the invention provide a multi-dimensional or multi-sequence transformer, e.g., as shown in FIGS. 3A-3B, that inputs and outputs multiple anomaly severity sequences, in parallel, thus capturing the accurate parallelized timing and/or relationships between log file messages of multiple loggers.

Reference is made to FIGS. 3A-3B, which schematic illustrate a multi-sequence transformer 200 to predict future anomaly severity histograms for log files, in accordance with some embodiments of the invention. Transformer 200 is divided into two figures such that the right-most dotted arrows of FIG. 3A connect to the left-most dotted lines of FIG. 3B. Dimensions of data structures in these figures are indicated in hard brackets to the right of the associated data structure and are provided as non-limiting examples.

Multi-dimensional or multi-sequence transformer 200 inputs a plurality of integer Q anomaly severity sequences 202a, 202b, 202c, . . . in parallel, for example, each generated by a different one of a plurality of Q loggers of an industrial machine (instead of a single input sequence 102 in FIG. 2). Each sequence 202a, 202b, 202c, . . . may have the same (or different) integer length or number of entries ki, Δti, si (e.g., recorded at times t1, t2, . . . , T). Components logged synchronously (e.g., periodically) may have non-zero tokens at each time, while components logged asynchronously (e.g., triggered by component-specific events) may have zero or null tokens (e.g., when no data is recorded) or combined tokens (e.g., averaged or self-verifying values or codes when recording at a higher frequency than the rate of the log file sequence).

A plurality of Q input embeddings 206a, 206b, 206c, . . . may each embed a respective one of the plurality of Q input sequences 202a, 202b, 202c, . . . into T embedded input vectors 208a, 208b, 208c, . . . in a high-dimensional vector space to generate a total of a product of the number of input sequences Q×T embedded input vectors. Each of the Q groups of T embedded input vectors 208a, 208b, 208c, . . . may be input into encoder 242. Whereas an LLM predicting a next token generates embedded input token vectors of dimension [Q×sentence length p×vocabulary size N](e.g., 3×5×50,000), the transformer 200 generates embedded input severity vectors 208a, 208b, 208c, . . . of dimension [Q×number of severity levels×number of severity embeddings (e.g., a number of patterns representing interrelationships between log tokens and the anomaly severity levels)](e.g., 3×5×256). An optimal number of severity embeddings for M=5-10 has been experimentally determined to be 128, 256 or 512 and is significantly less than vocabulary size N. In the above example, a reduction in the dimension of embedded input vectors from [3×5×50,000] in N-dimension LLMs to [3×5×256] in each of vectors 208a, 208b, 208c, . . . of LLM 200 yields approximately a 200× reduction in storage usage and a 200× speedup in processing time for this layer, and further reductions in subsequent hidden layers.

Multi-sequence transformer 200 may have an encoder 242 comprising a plurality of integer Q “Intra Series” multi-head self-attention layers 210a, 210b, 210c, . . . and an “Inter Series” multi-head self-attention layer 211 (instead of a single sequence multi-head self-attention layer 110 in FIG. 2). Each of the Q groups of T embedded input vectors 208a, 208b, 208c, . . . may be input into a respective one of the intra series multi-head self-attention layers 210a, 210b, 210c, . . . . Each intra series multi-head self-attention layer 210i performs self-attention on the T embedded vectors 208i embedding each single input sequence 202i by weighing the importance of embeddings of different tokens in the same input sequence 202i, in parallel, for each token in the same sequence. The plurality of Q intra series multi-head self-attention layers 210a, 210b, 210c, . . . thus output a plurality of Q respective groups of T intra series attention vectors that identify intra-logger embedded patterns within each single input sequence 202i (between events recorded by the same logger). Compared to next token LLMs, the drastic reduction in dimensions of embedded input severity vectors 208a, 208b, 208c, . . . in transformer 200 cause the plurality of Q intra series multi-head self-attention layers 210a, 210b, 210c, . . . to operate thereon at significantly faster speeds (e.g., tens or hundreds times faster with tens or hundreds times fewer computations and memory resources). In this example, a reduction in the dimension of each of the embedded input severity vectors 208a, 208b, 208c, . . . from [3×5×50,000] in N-dimension LLMs to [3×5×256] in vectors 208a, 208b, 208c, . . . of transformer 200 yields approximately a 200× reduction in storage usage and a 200× speedup in processing time for each of the plurality of Q intra series multi-head self-attention layers 210a, 210b, 210c, . . . , and further reductions in subsequent hidden layers.

The Q×T intra series attention vectors are then input into the inter series multi-head self-attention layer 211. Inter series multi-head self-attention layer 211 performs self-attention on the Q×T intra series attention vectors by weighing the importance of all other vector indices, . . . , in parallel, for each vector index. Since each of the Q groups of intra series attention vectors identify embedded patterns within each single input sequence 202i logged by the same logger, the Q×T inter series attention vectors which identify patterns across these Q groups (for all vector index combinations) identify embedded severity patterns associated with multiple different input sequences logged by multiple different loggers. These inter-logger embedded patterns across different logger sequences (between events recorded by different loggers) are often important for detecting normal or abnormal behavior. For example, different components of a system may be interconnected, such that multiple components must be collectively monitored together, and may be collectively responsible for, or supporting evidence of, normal or abnormal component function. In one example, a change in temperature in one component may be normal if it occurs concurrently with a change in pressure in another component, but abnormal if it occurs alone. Inter series multi-head self-attention layer 211 may thus detect inter-component patterns recorded in parallel across multiple different loggers. Accordingly, the inter-logger patterns detected in multi-sequence transformer 200 of FIGS. 3A-3B (detecting inter multi-component patterns recorded concurrently by different loggers) could not be detected by using multiple single-sequence transformers 100 of FIG. 2 (each only detecting single intra-component patterns recorded by the same single logger).

Encoder 242 may input the Q×T inter series attention vectors into a fully connected layer and/or normalization layer(s). Encoder 242 in FIG. 3A may then output Q×T encoded vectors 218 (e.g., the number Q of input sequences×the length T of each sequence) (e.g., whereas encoder 142 of FIG. 2 encodes a single vector of length T).

In FIG. 3B, when transformer 200 is iterated (e.g., to predict anomaly severity histograms 204a, 204b, 204c, . . . for multiple future subsequent iterations or times T+1, T+2, . . . ), decoder 244 may input severity embeddings of the output anomaly severity histograms 204a, 204b, 204c, . . . from a previous iteration (e.g., {Paₛᵢ}, {Pbₛᵢ}, {Pcₛᵢ}∀i=1, . . . , M at respective times T+1, T+2, . . . ) to predict the next set of output anomaly severity histograms 204a, 204b, 204c, . . . in the current iteration.

The Q output sequences 220a, 220b, 220c may each be embedded by a respective one of the plurality of N output embeddings 222a, 222b, 222c, . . . into T embedded output vectors 224a, 224b, 224c, . . . in a high-dimensional vector space, to generate a total of Q×T embedded output vectors. Embedded output severity vectors 224a, 224b, 224c, . . . may each represent the interrelationship, such as, the semantic meanings, between each respective logger's histogram output probabilities Psi for each severity level and the output probabilities for the logger's other M−1 severity level in the output anomaly severity histogram 204i.

Each of the Q groups of T embedded output vectors 224a, 224b, 224c, . . . may be input into a respective one of the Q intra series masked multi-head self-attention layers 226a, 226b, 226c, . . . to generate a respective one of a plurality of integer Q intra series output attention vectors. Each of the Q groups of T intra series output attention vectors may identify intra-logger embedded patterns within each single output sequence 220i (between events recorded by the same logger). The Q×T intra series output attention vectors are then input into the inter series multi-head self-attention layer 227. Inter series multi-head self-attention layer 227 performs self-attention on all index combinations of the Q×T intra series output attention vectors, in parallel, to identify patterns associated across multiple different output sequences logged by multiple different loggers. Compared to next token LLMs, the drastic reduction in dimensions of embedded input severity vectors 224a, 224b, 224c, . . . in transformer 200 cause the Q intra series masked multi-head self-attention layers 226a, 226b, 226c, . . . to operate thereon at significantly faster speeds (e.g., tens or hundreds times faster with tens or hundreds times fewer computations and memory resources). In this example, a reduction in the dimension of embedded output vectors from [3×1×50,000] in N-dimension LLMs to [3×5×256] in vectors 224a, 224b, 224c, . . . of transformer 200 yields approximately a 40× reduction in storage usage and a 40× speedup in processing time.

Decoder 244 in FIG. 3B may also comprise a plurality of integer Q intra series masked multi-head self-attention layers 230a, 230b, 230c, . . . and an inter series multi-head self-attention layer 231. Decoder 244 may input Q×T encoded vectors 218 from FIG. 3A, and for example when the current iteration's anomaly severity histograms are predicated on a previous iteration's anomaly severity histograms, may also input Q×T masked multi-head self-attention layer 226a, 226b, 226c, . . . output sequence from FIG. 3B.

The Q intra series masked multi-head self-attention layers 230a, 230b, 230c, . . . may perform self-attention analysis on the Q groups of T vectors independently and the inter series multi-head self-attention layer 231 may perform self-attention analysis across all Q×T vectors interdependently. The output of multi-head self-attention layer 231 may be input into a fully connected layer and/or normalized layer(s).

Decoder 244 may then output Q groups of T vectors to be sorted into and modeled by a plurality of integer Q respective linear layers 238a, 238b, 238c, . . . into a plurality of integer Q results respectively associated with the plurality of Q input sequences 202a, 202b, 202c, . . . . Each of the Q respective linear layers 238a, 238b, 238c, . . . is then passed to a respective one of a plurality of N softmax layers 240a, 240b, 240c, . . . . The plurality of Q separate softmax layers 240a, 240b, 240c, . . . may generate N separate respective anomaly severity histogram 204a, 204b, 204c, . . . , {Paₛᵢ}, {Pbₛᵢ}, {Pcₛᵢ}∀i=1, . . . , M at subsequent (future) times T+1, T+2, . . . predicting, for each histogram, a plurality of M distinct probabilities {Ps1, Ps2, . . . , PsM} that a future log key at a subsequent time will be associated with M respective distinct anomaly severity levels {s1,s2, . . . , sM}.

Multi-sequence transformer 200 thus predicts a plurality of Q anomaly severity histograms 204a, 204b, 204c, . . . in parallel, based on the multi-logger patterns embedded in multiple different input anomaly severity sequences 202a, 202b, 202c, . . . , recorded by multiple different loggers, for example, detected by inter series multi-head self-attention layer(s) 211, 227 and/or 231. In some embodiments, because performance and function of multiple components and/or loggers is often interrelated, the multi-sequence transformer 200 ability to predict normal or abnormal behavior based on interrelationships among multiple loggers and/or components may improve log file training accuracy for abnormal behavior prediction, for example, as compared to the single-sequence transformer 100 that can only predict behavior based on a single logger or component at a time.

During training mode, multi-sequence transformer 200 continuously inputs the N input anomaly severity sequences 202a, 202b, 202c, . . . until time T. Transformer 200 may then predict the anomaly severity histograms 204a, 204b, 204c, . . . , at one or more subsequent times e.g. T+1 for each of the N sequences (e.g., the next reading for temperature, pressure, humidity, etc.). The actual anomaly severity histogram may be generated from metadata of log files or measured component malfunctions (e.g., by self-supervised learning) and training errors may be calculated (e.g., as the difference between the predicted and actual anomaly severity histograms at the one or more subsequent times). Transformer 200 may update (e.g., all or a subset of) the weights of transformer 200, e.g., using backpropagation, evolutionary modeling, or other error correction mechanisms to minimize errors. These operations may be repeated until the predicted and actual logged tokens match with an above threshold accuracy (e.g., the error or difference between prediction and actual result is smaller than a predefined threshold) and/or the predictive confidence of softmax layers 240a, 240b, 240c, . . . , satisfies a training termination criterion (e.g., the probability distribution, mean, standard deviation, or maximum value reaches a threshold range and/or converges). At this point, transformer 200 is trained, and may be retrained e.g. periodically or each time new data becomes available.

Components not specifically described in reference to FIGS. 3A-3B may operate similarly to those described in FIG. 2, e.g., modified based on the parallelized multi-sequence architecture.

During training of single-sequence transformer 100 of FIG. 2 or multi-sequence transformer 200 of FIGS. 3A-3B, the probabilities of softmax layer(s) may be used as a measure of error to calibrate error correction. For example, if the probabilit(ies) of the output anomaly severity histograms are relatively low (e.g., less than 0.5 or 50% change of being correct), relatively high error correction is needed. For example, the lower the probability (greater the error), the higher the degree of correction the transformer training applies (e.g., greater the weight correction and/or number of training iterations). In some embodiments, training continues until one or more metric(s) of softmax layer(s) probabilit(ies) (e.g., distribution, mean, standard deviation, maximum value) reach one or more threshold range(s) and/or converge to satisfy one or more training termination criteria.

Single-sequence transformer 100 of FIG. 2 and multi-sequence transformer 200 of FIGS. 3A-3B are illustrated with example layer configurations that may be reordered, duplicated, substituted and/or deleted. In one example, in FIGS. 3A-3B, the order of intra and inter series components may be switched, so that for example, embedded input vectors 208a, 208b, 208c, . . . are input into an inter series multi-head self-attention layer before they are input into Q intra series multi-head self-attention layers. The above benefits of computational speed-up and memory reduction at the input layer may thus occur at the inter series multi-head self-attention layer. Additionally or alternatively, either encoder or decoder may be deleted or one or both of encoder and decoder may be replicated to add as many iterations of encoding and/or decoding as desired. Additionally or alternatively, the number of Q intra series multi-head self-attention layers executed in parallel may be increased to input one or more input embedding vectors into multiple intra series multi-head self-attention layers. Additionally or alternatively, multiple inter series multi-head self-attention layers may be executed in parallel. Additionally or alternatively, skip connections may be added throughout the transformers 100 and 200 to add extra input to one or more layers. For example, skip connection 209 in FIG. 3A input raw embedded input vector 208a into inter series multi-head self-attention layer 211 (e.g., in addition to intra series attention vectors). Any other skip connections may be used.

Transformers described in reference to FIGS. 2-3B may operate as described in U.S. patent application Ser. No. 18/458,289 filed on Aug. 30, 2023, which is incorporated herein by reference in its entirety.

Data structures described in reference to FIGS. 1-3B may be stored in memory (e.g., memory units 416 and 426 of FIG. 4) and generated and processed by a processor or controller (e.g., processor 414 and 424 of FIG. 4).

Reference is made to FIG. 4, which schematically illustrates a system 400 for analyzing log files of industrial machine(s) 450 using large language model(s), in accordance with some embodiments of the invention. System 400 may store and/or generate an LLM (e.g., LLM 109, transformer 100 and/or transformer 200), store and/or generate industrial machine log files, train and/or predict log file tokens using LLM 109, transformer 100 and/or transformer 200, and/or predict and/or prevent industrial machine 450 failure or malfunction, as described in reference to FIGS. 1-3B and 5.

System 400 may include one or more device(s) 450, such as industrial machines or any other device that generates log files, and one or more remote server(s) 410 accessible to device(s) 450 via a network and/or computing cloud 420. Typically, the LLM is trained by remote server 410 and run for prediction remotely at remote server 410, or locally at one or more devices 450, although either remote server 410 and/or local devices 450 may train and/or predict the LLM according to embodiments of the invention. In particular, sparsifying the LLM significantly reduces the computational effort for prediction and training, as compared to conventional fully-activated neural networks or layers, to allow local devices 450, which may have limited memory and processing capabilities, to quickly and efficiently perform such prediction and/or training. When local devices 450 perform training and runtime prediction, remote server 410 may be removed. Removing remote training and/or prediction may allow local devices 450 to operate the LLM even if they are disconnected from the cloud, if the input rate is so high that it is not feasible to continuously communicate with the cloud, or if very fast prediction is required where even the dedicated hardware is not fast enough today (e.g., deep learning for high frequency trading).

Remote server 410 has a memory 416 and processor 414 for storing and retrieving a LLM and log file(s). Remote server 410 may store a complete LLM (e.g., transformer 100 of FIG. 2 or 200 of FIGS. 3A-3B) and remote processor 414 may activate the LLM for training and/or prediction. In some embodiments, remote server 410 may have specialized hardware including a large memory 416 for storing a transformer/log file(s) and a specialized processor 414 (e.g., a GPU). Memory 416 may store data 418 including a training dataset of log file(s) and data representing a plurality of weights of synapses or filters of the LLM. Data 418 may also include code (e.g., software code) or logic, e.g., to enable storage and retrieval of data 418 according to embodiments of the invention.

An exploded view “A” of a representative industrial machine 450 is shown in FIG. 4. All other industrial machines 450 may have any combination of the same or different components described in reference to A. Industrial machine(s) 450 may include a plurality of loggers 430 that may be hardware or software programs that generate log files of recorded or measured parameters of one or more hardware or software components 432. The correspondence between loggers 430 and the hardware component 432 for which the logger records data may be one-to-one, one-to-many, many-to-one or many-to-many. For example, two loggers may record the temperature and pressure, respectively, of the same 3D printer.

Remote server 410 and/or industrial machine(s) 450 may each include one or more memories 416 and/or 426 for storing a LLM (e.g., transformer 100 of FIG. 1 or 200 of FIGS. 3A-3B) provided in some embodiments of the invention. Memories 416 and/or 426 may store each of a plurality of weights of synapses or filters of the transformers and one or more associated input anomaly severity sequences, output anomaly severity histograms, input embeddings, output embeddings, input embedded vectors, output embedded vectors, intra series attention vectors, inter series attention vectors, encoded vectors, softmax probabilities, etc. Remote server 410 and/or industrial machine(s) 450 may each include one or more processor(s) 414 and/or 424 for executing the LLM for training and/or prediction, to predict abnormal behavior of industrial machine(s) 450 by analyzing anomaly severity histogram associated with the log file messages output by loggers 430. During prediction, the LLM is run forward once. During training, the LLM is run twice, once forward to generate an output and once backwards for error correction (e.g., backpropagation), repeated many iterations until training is complete.

Remote processor 414 and/or local processor 424 may store a plurality of Q input anomaly severity sequences comprising t log tokens (ki), times between log file token pairs (Δti), and anomaly severity levels (si) associated with one or more of the log tokens, each ith anomaly severity sequence generated by a different ith one of a plurality of respective logger 430, for example, recording one or more industrial machine components 432. Remote processor 414 and/or local processor 424 may input t embeddings of each of Q input sequences of log file tokens into Q respective intra sequence multi-head self-attention layers and output Q respective intra sequence attention vectors identifying t patterns between token anomaly severity levels within the same input sequence and logged by the same logger 430. Remote processor 414 and/or local processor 424 may input the Q intra sequence attention vectors into an inter sequence multi-head self-attention layer and output Q×t inter sequence attention vectors identifying Q×t patterns associated with tokens from multiple different input sequences and logged by multiple different loggers 430. Remote processor 414 and/or local processor 424 may generate, based on machine learning of the Q×t inter sequence attention vectors, a plurality of Q softmax layers of Q distinct anomaly severity histograms each predicting a plurality of M distinct probabilities {Ps1, Ps2, . . . , PsM} that the one or more loggers will record log file messages encoded by one or more log keys associated with M respective distinct anomaly severity levels {s1, s2, . . . , sM} at the one or more subsequent times.

Network 420, which connects industrial machine(s) 450 and remote server 410, may be any public or private network such as the Internet. Access to network 420 may be through wire line, terrestrial wireless, satellite or other systems well known in the art.

Industrial machine(s) 450 and remote server 410 may include one or more controller(s) or processor(s) 414 and 424, respectively, for executing operations according to embodiments of the invention and one or more memory unit(s) 416 and 426, respectively, for storing data 418 and/or instructions (e.g., software for applying methods according to embodiments of the invention) executable by the processor(s). Processor(s) 414 and 424 may include, for example, a central processing unit (CPU), a graphical processing unit (GPU, a field-programmable gate array (FPGA), an application-specific integrated circuit (ASIC), a digital signal processor (DSP), a microprocessor, a controller, a chip, a microchip, an integrated circuit (IC), or any other suitable multi-purpose or specific processor or controller. Memory unit(s) 416 and 426 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

Other devices and configurations may be used, for example, data 418 may be stored locally in memory 426 and no separate server 410 may be used.

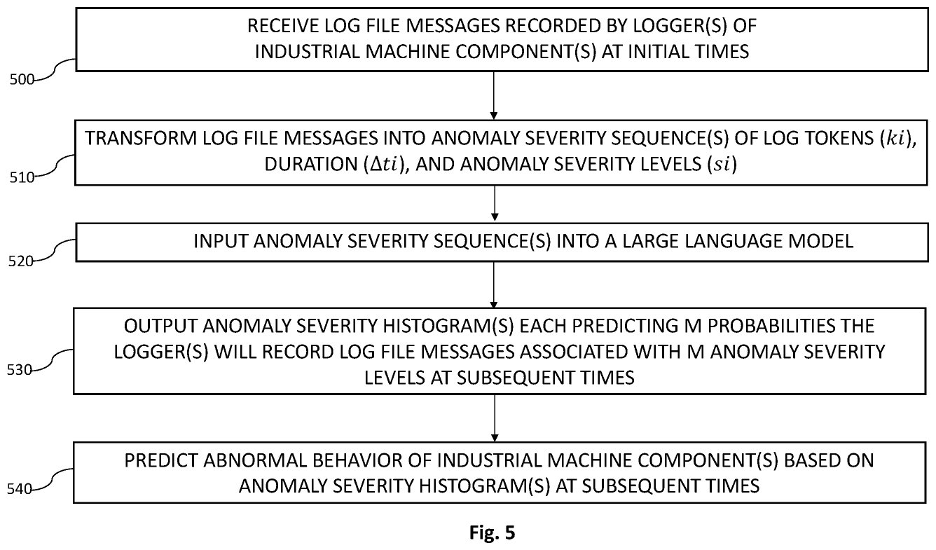

Reference is made to FIG. 5, which is a flowchart of a method for detecting abnormal behavior in industrial machines by predicting future anomaly severity histograms for log files, in accordance with some embodiments of the invention. The operations of FIG. 5 may be executed by a processor (e.g., one or more processor(s) 414 and/or 424 of FIG. 4) using data stored in a memory (e.g., one or more memory unit(s) 416 and/or 426 of FIG. 4).

In operation 500, a processor may receive, from one or more loggers recording operations of one or more components in an industrial machine, a sequence of log file messages {log 1, log 2, . . . , logq} recorded by the one or more loggers at one or more initial times.

In operation 510, a processor may transform the sequence of log file messages into an anomaly severity sequence {k1,Δt1, s1; k2,Δt2,s2; . . . ; kp, Δtp,sp} comprising a sequence of log tokens (ki) encoding the log file messages, time between log file token pairs (Δti), and/or a sequence of anomaly severity levels (si) each associated with one or more of the log tokens. In some embodiments the processor may perform self-supervised training to automatically label the sequence of log tokens (ki) with the sequence of anomaly severity levels (si), e.g., based on the associated log message metadata or the log messages themselves, using rules, machine learning or other analysis.

In operation 520, a processor may input the anomaly severity sequence at the one or more initial times into the large language model trained to predict anomaly severity histograms at one or more subsequent times. Since the LLM models anomaly severity histogram for a number M of anomaly severity levels that is significantly smaller than a number N of all possible log tokens, modeling those severity levels provides a relatively more compact and efficient model that uses reduced dimensional data structures (see e.g., FIGS. 2-3B), reduced memory usage, reduced computations, and increases processing speeds, compared to next token LLM prediction. Reduced dimensional input data structures (e.g., 108, 124 of FIGS. 2 and/or 208a, 208b, 208c, . . . , 224a, 224b, 224c, of FIGS. 3A-3B) having a dimension on an order of a product of the number M of anomaly severity levels and a number of patterns representing interrelationships between log tokens and the anomaly severity levels result in reduced processing by the input layer (e.g., 1108, 126 of FIGS. 2 and/or 210a, 210b, 210c, . . . , 226a, 226b, 226c, of FIGS. 3A-3B) and/or one or more subsequent layers. The input layer (e.g., 1108, 126 of FIGS. 2 and/or 210a, 210b, 210c, . . . , 226a, 226b, 226c, of FIGS. 3A-3B).

In operation 530, a processor may output from the large language model, based on the anomaly severity sequence at the one or more initial times, an anomaly severity histogram predicting a plurality of M distinct probabilities {Ps1, Ps2, . . . , PsM} that the one or more loggers will record log file messages encoded by one or more log keys associated with M respective distinct anomaly severity levels {s1,s2, . . . , sM} at the one or more subsequent times. The anomaly severity histogram may predict the same number M of probabilities for any timescale defined by the one or more subsequent times and so need only predicted once with one LLM execution to determine severity level prediction for a large future timescale (e.g., executed once for a 10 minute duration), whereas a next token prediction is determined for a particular time and thus is iterated many times for larger timescales (e.g., executed thousands of times for a 10 minute duration).

In operation 540, a processor may predict abnormal behavior in the one or more components of the industrial machine logged by the one or more loggers at the one or more subsequent times when the anomaly severity histogram indicates a pattern of the M probabilities trained to be associated with the abnormal behavior. Upon predicting the abnormal behavior, a processor may send the industrial machine a control command (e.g., “Triger Action” control command in FIG. 1) to trigger the industrial machine to automatically execute an action to prevent the abnormal behavior from occurring before the one or more subsequent times. The control command may trigger the industrial machine to automatically alter the operation of the one or more components predicted to have abnormal behavior.

In some embodiments, the large language model of operation 520 is a single-sequence transformer (e.g., 100 of FIG. 2). This single-sequence transformer may generate embedded input and/or output severity vectors representing interrelationships between entries of input and/or output anomaly severity sequence, wherein the embedded input and/or output severity vectors have a dimension on an order of a product of embedding input and/or output severity vectors. The single-sequence transformer may then process the embedded input and/or output severity vectors at an encoder and/or decoder of the transformer.

In some embodiments, the large language model of operation 520 is a multi-sequence transformer (e.g., 200 of FIG. 3A-3B). This multi-sequence transformer may input a plurality of anomaly severity sequences of log file tokens transformed from a plurality of sequences of log file messages generated by a plurality of respective loggers. The multi-sequence transformer may generate a plurality of embedded input and/or output severity vectors derived from the plurality of respective anomaly severity sequences. The multi-sequence transformer may input the plurality of embedded input and/or output severity vectors into a plurality of distinct respective intra sequence multi-head self-attention layers to output a plurality of distinct respective sets of intra sequence attention vectors, each set identifying patterns associated with relationships among entries within the same anomaly severity sequence associated with the same logger. The multi-sequence transformer may input embedding patterns derived from a combination of the plurality of anomaly severity sequences into a same inter sequence multi-head self-attention layer to output a plurality of interrelated sets of inter sequence attention vectors identifying patterns associated with relationships among entries across multiple different ones of the anomaly severity sequences generated by multiple different loggers.

Other operations or orders of operations may be used.

The term large language model may refer to any large language model including, but not limited to one or more transformers, examples of which are schematically illustrated in FIG. 2 (single-sequence transformer 100) and/or FIGS. 3A-3B (multi-sequence transformer 200).

In the foregoing description, various aspects of the present invention are described. For purposes of explanation, specific configurations and details are set forth in order to provide a thorough understanding of the present invention. However, it will also be apparent to persons of ordinary skill in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which may comprise one or more executable instructions for implementing the specified logical function(s). In some alternative implementations, the functions noted in the block may occur out of the order noted in the figures or by different modules. Unless explicitly stated, the method embodiments described herein are not constrained to a particular order or sequence. Additionally, some of the described method embodiments or elements thereof can occur or be performed at the same point in time. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments of the invention may include an article such as a non-transitory computer or processor readable medium, or a computer or processor non-transitory storage medium, such as for example a memory (e.g., memory units 416 and 426 of FIG. 4), a disk drive, or a USB flash memory, encoding, including or storing instructions, e.g., computer-executable instructions, which, when executed by a processor or controller (e.g., processor 414 and 424 of FIG. 4), carry out methods disclosed herein.

In the above description, an embodiment is an example or implementation of the inventions. The various appearances of “one embodiment,” “an embodiment” or “some embodiments” do not necessarily all refer to the same embodiments. Although various features of the invention may be described in the context of a single embodiment, the features of embodiments may also be provided separately or in any suitable combination. Conversely, although the invention may be described herein in the context of separate embodiments for clarity, the invention may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

The descriptions, examples, methods and materials presented in the claims and the specification are not to be construed as limiting but rather as illustrative only. While certain features of the present invention have been illustrated and described herein, many modifications, substitutions, changes, and equivalents may occur to those of ordinary skill in the art. It is, therefore, to be understood that the appended claims are intended to cover all such modifications and changes as fall with the true spirit of the invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus certain embodiments may be combinations of features of multiple embodiments.

1. A method of detecting abnormal behavior in industrial machines, the method comprising:
receiving, from one or more loggers recording operations of one or more components in an industrial machine, a sequence of log file messages recorded by the one or more loggers at one or more initial times;
transforming the sequence of log file messages into an anomaly severity sequence comprising a sequence of log tokens encoding the log file messages, time between log file token pairs, and a sequence of anomaly severity levels each associated with one or more of the log tokens;
inputting the anomaly severity sequence at the one or more initial times into the large language model trained to predict anomaly severity histograms at one or more subsequent times;
outputting from the large language model, based on the anomaly severity sequence at the one or more initial times, an anomaly severity histogram predicting a plurality of M distinct probabilities that the one or more loggers will record log file messages encoded by one or more log keys associated with M respective distinct anomaly severity levels at the one or more subsequent times; and
predicting abnormal behavior in the one or more components of the industrial machine logged by the one or more loggers at the one or more subsequent times when the anomaly severity histogram indicates a pattern of the M probabilities associated with the abnormal behavior.

2. The method of claim 1 comprising, upon predicting the abnormal behavior, sending the industrial machine a control command to trigger the industrial machine to automatically execute an action to prevent the abnormal behavior from occurring before the one or more subsequent times.

3. The method of claim 2, wherein the control command triggers the industrial machine to automatically alter the operation of the one or more components predicted to have abnormal behavior.

4. The method of claim 1, wherein the number M of anomaly severity levels is significantly smaller than a number N of log tokens.

5. The method of claim 1, wherein one or more layers of the large language model process the anomaly severity sequence that is represented by a data structure having a dimension on an order of a product of the number M of anomaly severity levels and a number of patterns representing interrelationships between log tokens and the anomaly severity levels.

6. The method of claim 1, wherein the anomaly severity histogram predicts the same number M of probabilities for any timescale defined by the one or more subsequent times.

7. The method of claim 1, wherein the large language model is a single-sequence transformer, the method further comprising:
generating embedded input and/or output severity vectors representing interrelationships between entries of input and/or output anomaly severity sequence, wherein the embedded input and/or output severity vectors have a dimension on an order of a product of embedding input and/or output severity vectors; and
processing the embedded input and/or output severity vectors at an encoder and/or decoder of the transformer.

8. The method of claim 1, wherein the large language model is a multi-sequence transformer, the method further comprising:
inputting a plurality of anomaly severity sequences of log file tokens transformed from a plurality of sequences of log file messages generated by a plurality of respective loggers;
generating a plurality of embedded input and/or output severity vectors derived from the plurality of respective anomaly severity sequences;
inputting the plurality of embedded input and/or output severity vectors into a plurality of distinct respective intra sequence multi-head self-attention layers to output a plurality of distinct respective sets of intra sequence attention vectors, each set identifying patterns associated with relationships among entries within the same anomaly severity sequence associated with the same logger; and
inputting embedding patterns derived from a combination of the plurality of anomaly severity sequences into a same inter sequence multi-head self-attention layer to output a plurality of interrelated sets of inter sequence attention vectors identifying patterns associated with relationships among entries across multiple different ones of the anomaly severity sequences generated by multiple different loggers.

9. The method of claim 1 comprising performing self-supervised training to automatically label the sequence of log tokens with the sequence of anomaly severity levels.

10. A system for detecting abnormal behavior in industrial machines, the system comprising:
one or more memories configured to store a sequence of log file messages, recorded at one or more initial times by one or more loggers, of operations of one or more components in an industrial machine; and
one or more processors configured to:
transform the sequence of log file messages into an anomaly severity sequence comprising a sequence of log tokens encoding the log file messages, time between log file token pairs, and a sequence of anomaly severity levels each associated with one or more of the log tokens,
input the anomaly severity sequence at the one or more initial times into the large language model trained to predict anomaly severity histograms at one or more subsequent times,
output from the large language model, based on the anomaly severity sequence at the one or more initial times, an anomaly severity histogram predicting a plurality of M distinct probabilities that the one or more loggers will record log file messages encoded by one or more log keys associated with M respective distinct anomaly severity levels at the one or more subsequent times, and
predict abnormal behavior in the one or more components of the industrial machine logged by the one or more loggers at the one or more subsequent times when the anomaly severity histogram indicates a pattern of the M probabilities associated with the abnormal behavior.

11. The system of claim 10, wherein the one or more processors are configured to, upon predicting the abnormal behavior, send the industrial machine a control command to trigger the industrial machine to automatically execute an action to prevent the abnormal behavior from occurring before the one or more subsequent times.

12. The system of claim 11, wherein the control command triggers the industrial machine to automatically alter the operation of the one or more components predicted to have abnormal behavior.

13. The system of claim 10, wherein the number M of anomaly severity levels is significantly smaller than a number N of log tokens.

14. The system of claim 10, wherein one or more layers of the large language model process the anomaly severity sequence that is represented by a data structure having a dimension on an order of a product of the number M of anomaly severity levels and a number of patterns representing interrelationships between log tokens and the anomaly severity levels.

15. The system of claim 10, wherein the anomaly severity histogram predicts the same number M of probabilities for any timescale defined by the one or more subsequent times.

16. The system of claim 10, wherein the large language model is a single-sequence transformer and the one or more processors are configured to:
generate embedded input and/or output severity vectors representing interrelationships between entries of input and/or output anomaly severity sequence, wherein the embedded input and/or output severity vectors have a dimension on an order of a product of embedding input and/or output severity vectors, and
process the embedded input and/or output severity vectors at an encoder and/or decoder of the transformer.

17. The system of claim 10, wherein the large language model is a multi-sequence transformer and the one or more processors are configured to:
input a plurality of anomaly severity sequences of log file tokens transformed from a plurality of sequences of log file messages generated by a plurality of respective loggers,
generate a plurality of embedded input and/or output severity vectors derived from the plurality of respective anomaly severity sequences,
input the plurality of embedded input and/or output severity vectors into a plurality of distinct respective intra sequence multi-head self-attention layers to output a plurality of distinct respective sets of intra sequence attention vectors, each set identifying patterns associated with relationships among entries within the same anomaly severity sequence associated with the same logger, and
input embedding patterns derived from a combination of the plurality of anomaly severity sequences into a same inter sequence multi-head self-attention layer to output a plurality of interrelated sets of inter sequence attention vectors identifying patterns associated with relationships among entries across multiple different ones of the anomaly severity sequences generated by multiple different loggers.

18. The system of claim 10, wherein the one or more processors are configured to perform self-supervised training to automatically label the sequence of log tokens with the sequence of anomaly severity levels.

19. A non-transitory computer-readable storage medium comprising instructions that when executed cause one or more processors to:
receive, from one or more loggers recording operations of one or more components in an industrial machine, a sequence of log file messages recorded by the one or more loggers at one or more initial times;
transform the sequence of log file messages into an anomaly severity sequence comprising a sequence of log tokens encoding the log file messages, time between log file token pairs, and a sequence of anomaly severity levels each associated with one or more of the log tokens;
input the anomaly severity sequence at the one or more initial times into the large language model trained to predict anomaly severity histograms at one or more subsequent times;
output from the large language model, based on the anomaly severity sequence at the one or more initial times, an anomaly severity histogram predicting a plurality of M distinct probabilities that the one or more loggers will record log file messages encoded by one or more log keys associated with M respective distinct anomaly severity levels at the one or more subsequent times; and
predict abnormal behavior in the one or more components of the industrial machine logged by the one or more loggers at the one or more subsequent times when the anomaly severity histogram indicates a pattern of the M probabilities associated with the abnormal behavior.

20. The non-transitory computer-readable storage medium of claim 19 comprising instructions that, upon predicting the abnormal behavior, cause one or more processors to trigger the industrial machine to automatically execute an action to prevent the abnormal behavior from occurring before the one or more subsequent times.
